(19) United States
(12) Patent Application Publication
(10) Pub. No.: US 2021/0189669 A1
(43) Pub. Date: Jun. 24, 2021

(54) Method And Apparatus For Clearing Permeable Paver Joints

(71) Applicant: Frank Calistro, River Grove, IL (US)

(72) Inventor: Frank Calistro, River Grove, IL (US)

(21) Appl. No.: 17/089,500

(22) Filed: Nov. 4, 2020

Related U.S. Application Data
(60) Provisional application No. 62/930,469, filed on Nov. 4, 2019.

(51) Int. Cl. E01C 23/09; B60R 11/06; B08B 3/02; B08B 5/04

(52) U.S. Cl. CPC E01C 23/0926; B60R 11/06; B60R 2011/004; B08B 5/04; B08B 3/024

(57) ABSTRACT

An apparatus and method for clearing paver joints including high pressure water jets along a transverse direction to impact paver joints below the jets. The jets are moved in a longitudinal direction to clear joints in a transverse swath. The high pressure water jets are provided by plural nozzles arranged spaced-apart across the transverse direction and high pressure water is delivered through the nozzles to impact paver joints below the nozzles

This application claims the benefit of U.S. Ser. No. 62/930,469 filed Nov. 4, 2019.

### BACKGROUND OF THE INVENTION

One ground covering technique for parking lots, roadways, courtyards, etc. is to place pavers or bricks on a base of chip rock, separated by narrow joints. The chip rock also fills the joints between the individual pavers or bricks. The advantage of this configuration is that storm water on these surfaces will infiltrate through the joints into the ground below without accumulating on the surface. Over time the joints can become clogged and lose their infiltration performance.

It is sometimes necessary to clear or clean the joints between bricks or pavers when those joints are clogged with chip rock or other debris. It is known to use pressurized air to blow out the joints using push cart apparatus and collect the debris afterword with a vacuum truck.

The present inventor has recognized that it would be desirable to provide a machine and method for effectively, efficiently, and cost-effectively clearing the joints of pavers to rehabilitate the paved surface for water infiltration.

### SUMMARY

The present invention provides an effective apparatus and method for cleaning pavers and clearing joints between pavers. The apparatus includes a high pressure water source located within or on a vehicle, a plurality of nozzles arranged close to a paver surface to be cleaned and cleared, a header pipe connected to the nozzles, and a delivery pipe connected between the header pipe and the source of pressurized water.

A method according to the invention includes providing a source of pressurized water, providing a series of nozzles spread over a width of an area of the pavers to be cleaned and cleared, directing the pressurized water out of the nozzles to impact the pavers and paver joints, and moving the vehicle along the paver area to clean and clear a substantially wide swath of the paver area. Additionally, a vacuum truck or vacuum apparatus can follow the cleaning and clearing procedure to collect the cleared debris.

The high pressure water jets or spray dislodge the chip rock between pavers in the joints, the chip rock having been clogged with organic debris or other debris which inhibits its water permeability. After the chip rock is sprayed out, new and clean chip rock can be placed in the joints, making a permeable joint once again.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is a perspective view of a vehicle with the paver clearing apparatus according to an embodiment of the invention;

FIG. 2 is a front perspective view of the paver clearing apparatus of FIG. 1, separated from the vehicle;

FIG. 3 is a front perspective view of the apparatus of FIG. 2 with a front cover removed to see the underlying components;

FIG. 4 is a front fragmentary, enlarged perspective view of a center portion of FIG. 3;

FIG. 5 is a front fragmentary, enlarged perspective view of an end portion of FIG. 3;

FIG. 6 is a front, enlarged perspective view of the apparatus of FIG. 3 showing a mounting hitch supporting the apparatus;

FIG. 7 is a rear, enlarged perspective view of the mounting hitch shown in FIG. 6; and

FIG. 8 is a front, enlarged perspective view of the mounting hitch shown in FIG. 7.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

This application incorporates by reference U.S. Ser. No. 62/930,469 filed Nov. 4, 2019.

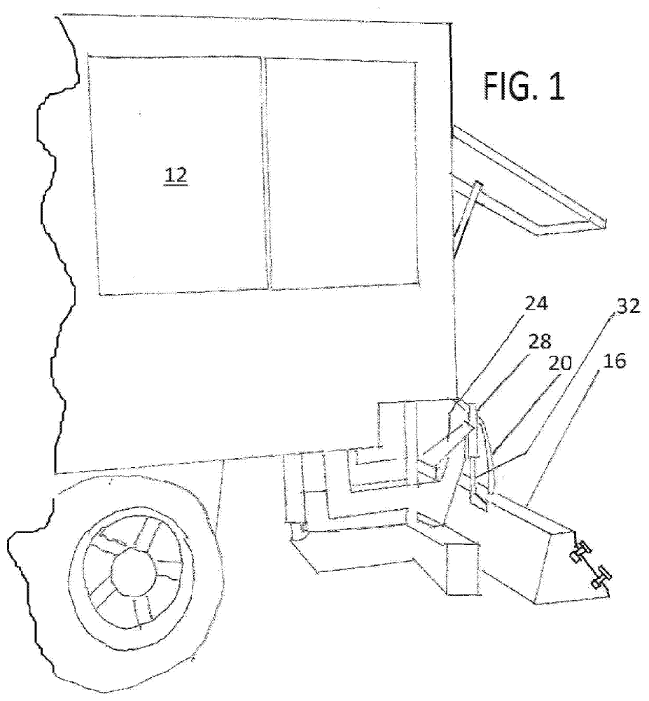

FIG. 1 shows an assembly 10 for performing the method of the invention. FIG. 1 shows a vehicle 12, such as a water tanker truck having a paver clearing apparatus 16 adjustably mounted to a rear thereof. Within the vehicle 12 is a water pump (not shown) which delivers high pressure water through a delivery tube or pipe 20 to the apparatus 16. A vehicle hitch 24 includes a receiver 28 which adjustably mounts an apparatus spindle 32. The high pressure water can be at 3000 psi.

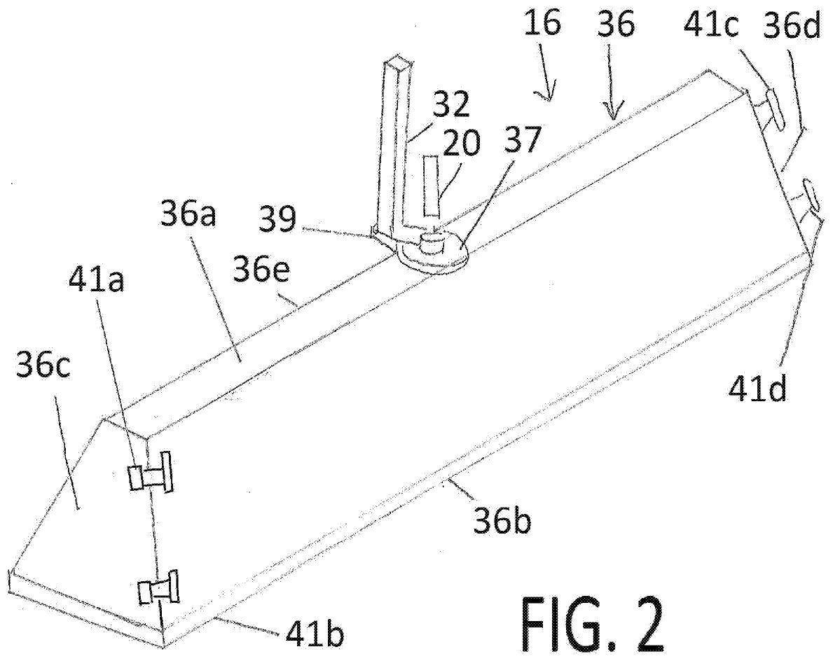

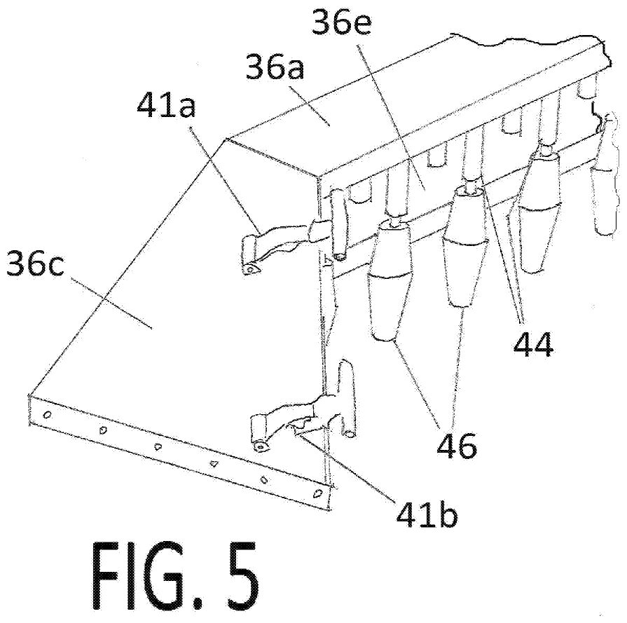

FIG. 2 shows the apparatus 16 in more detail. The apparatus includes an elongated housing 36 having a top wall 36a, a front wall 36b, a first side wall 36c, a second side wall 36d, and a rear wall 36e. The spindle 32 in the form of a square tube is mounted to the top wall 36a by a bracket 37. A nozzle 39 is mounted to the apparatus 16 through the bracket 37 and is flow-connected to the supply tube or pipe 20 at one end and to a horizontal header pipe 43 (shown schematically) within the housing 36 at the other end. The front wall 36b is removable and is connected by latches 41a, 41b, 41c, and 41d (FIG. 5).

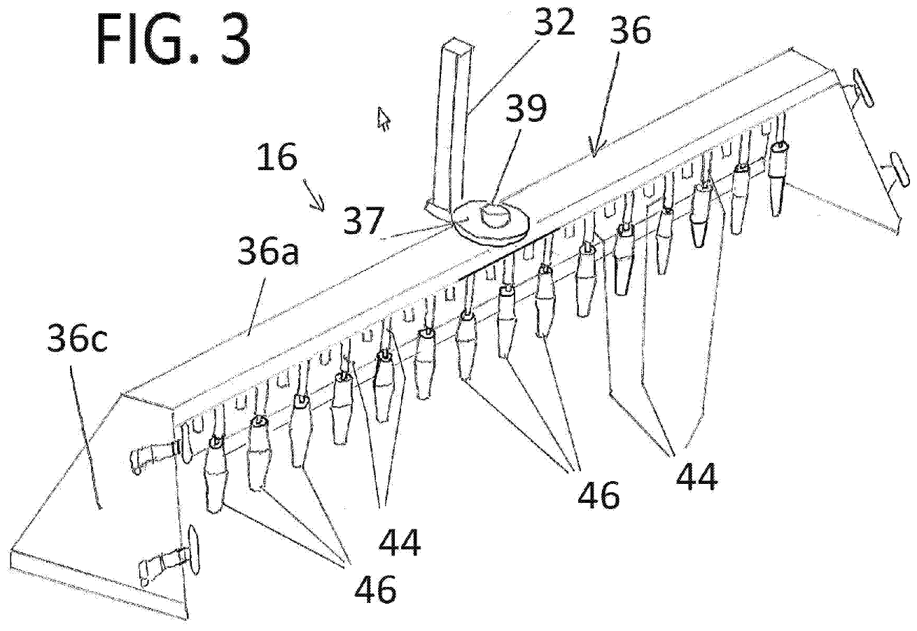

FIG. 3 shows the apparatus 16 of FIG. 2 with the front wall 36b removed. The nozzles 39 is connected to the horizontal header pipe 43 which flow-connects along its length to a plurality of pipe nipples 44, each nipple flow-connected to a high-pressure water nozzle 46. The nozzles 46 are arranged spaced apart along the length of the housing 36. The nozzles are directed downwardly to cause a high impact water jet to strike the pavers and joints between the pavers.

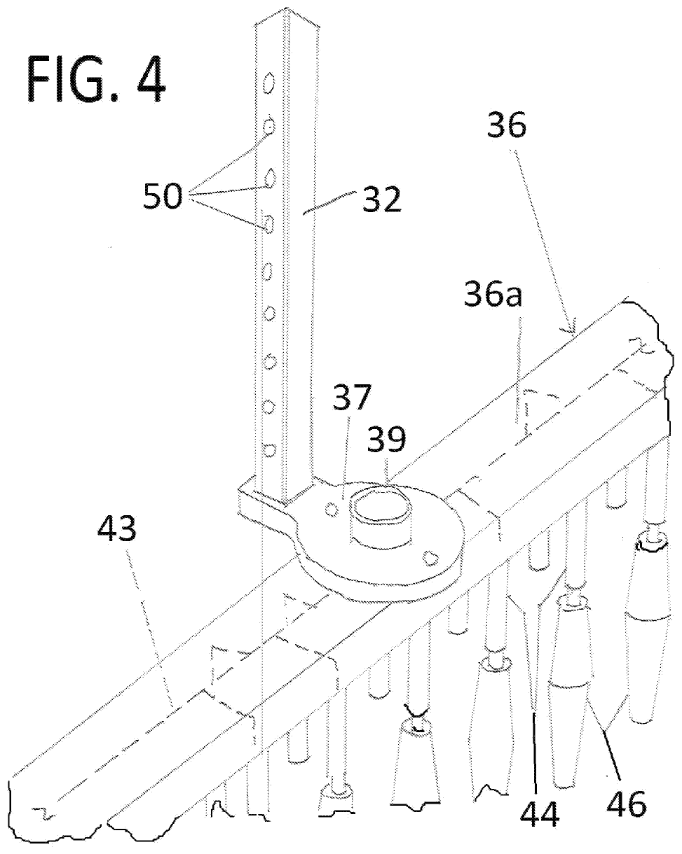

FIG. 4 shows the spindle 32 which has vertically spaced apart pin-receiving holes 50. The spindle 32 is inserted into the hitch receiver 28, also in the form of a square tube to a selected depth until one or more of the pin receiving holes 50 aligned with pin holes 60 through the hitch. A pin is then inserted through the receiver and the spindle to lock the apparatus 16 at the desired height above the paver area.

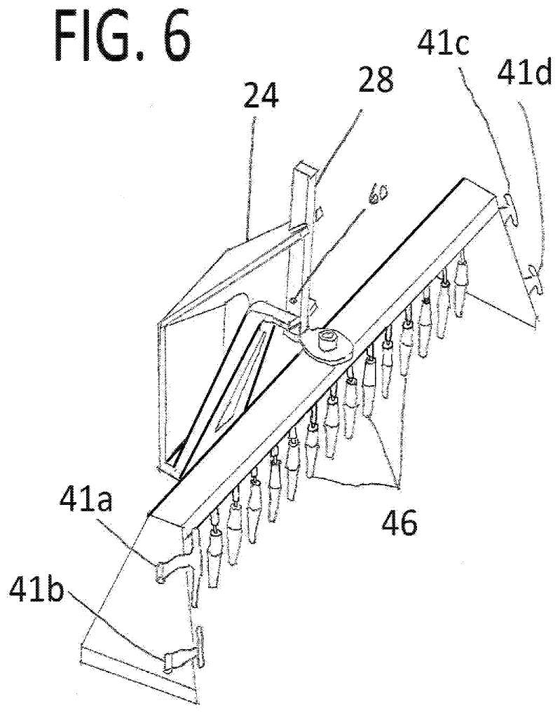

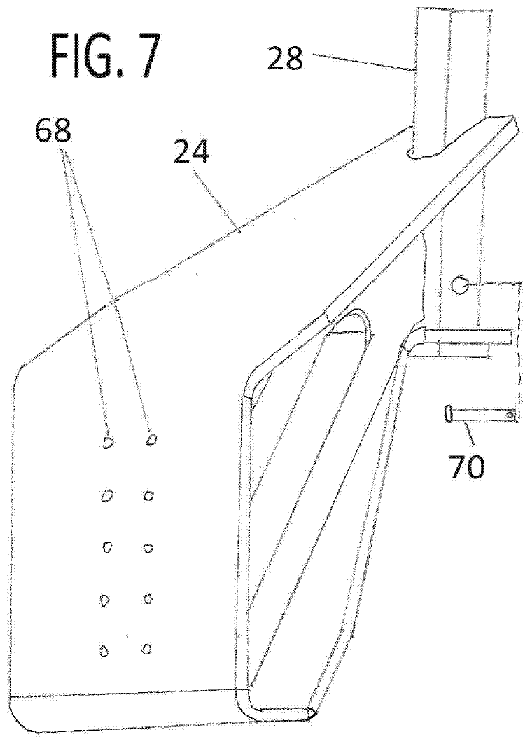

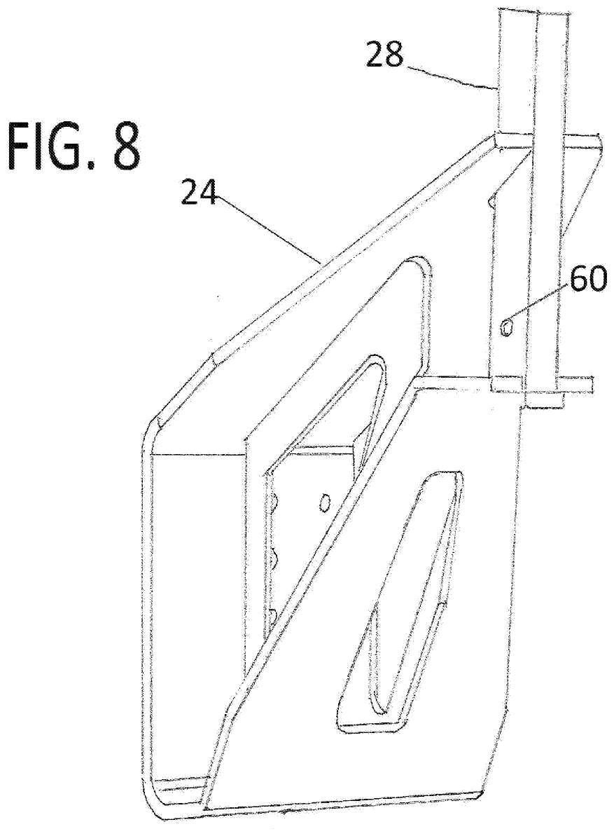

As shown in FIGS. 6 through 8, the hitch receiver 28 is welded to a rugged hitch 24 which includes fastening holes 68 on a rear side of the hitch such that the hitch can be attached at a select elevation to a variety of vehicles. As shown in FIG. 7, a pin 70 can be provided to pass through the hitch 28 and the spindle 32 at selectively aligned pin receiving holes through the two members to select the relative elevation between the apparatus 16 and the hitch 24.

In operation, the vehicle 10 slowly rolls along a paver surface to be cleared and cleaned. High-pressure water is delivered through the pipe 20 and to the horizontal header pipe within the housing 36. The horizontal header pipe delivers pressurized water through the pipe nipples 44 to the high-pressure water nozzles 46 to spray the pavers and the joints between pavers. Dirt and clogged joints can be thus cleared off the pavers and the joints. A vacuum truck can follow the vehicle to collect the debris.

Alternatively, the apparatus 16 can be mounted to a vacuum truck also having a high-pressure water supply and the spraying and the vacuuming of debris can take place during the same vehicle movement.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A method for clearing paver joints comprising the steps of:
providing high pressure water jets along a transverse direction to impact paver joints below the jets;
moving the jets in a longitudinal direction to clear joints in a transverse swath.

2. The method according to claim 1, wherein the step of providing high pressure water jets is further defined in that the jets are provided by plural nozzles arranged spaced-apart across the transverse direction and high pressure water is delivered through the nozzles to impact paver joints below the nozzles; and the step of moving the jets is further defined as moving the nozzles in a longitudinal direction to clear joints in a transverse swath.

3. The method according to claim 2, comprising the further step of vacuuming up debris cleared from the joints by the jets.

4. An apparatus for clearing paver joints of debris, comprising;
a housing;
a supply of pressurized water;
a header pipe carried by the housing;
a supply pipe flow-connected between the header pipe and the supply of pressurized water; and
a plurality of high pressure water nozzles, flow connected to the header pipe and spaced apart along the header pipe.

5. The apparatus according to claim 4, further comprising a hitch assembly for mounting the housing to a vehicle.

6. The apparatus according to claim 4, wherein the housing has a top wall, a front wall, a first side wall, a second side wall, and a rear wall; and comprising a spindle is in the form of a square tube mounted to the top wall by a bracket, wherein the spindle is inserted into a hitch receiver, connected to a vehicle.

7. The apparatus according to claim 6, comprising a nozzle mounted to the top wall via a bracket and is flow-connected to a supply pipe at one end and to the header pipe within the housing at an opposite end.

8. The apparatus according to claim 7, wherein the spindle is in the form of a square tube having vertically spaced apart pin-receiving holes, wherein when the spindle is inserted into the hitch receiver, also in the form of a square tube, to a selected depth one or more of the pin receiving holes align with pin holes through the hitch.

9. The apparatus according to claim 8, wherein the hitch receiver is welded to a rugged hitch which includes fastening holes on a rear side of the hitch such that the hitch can be attached at a select elevation to a variety of vehicles.
